(19) United States
(12) Patent Application Publication
(10) Pub. No.: US 2006/0045864 A1
(43) Pub. Date: Mar. 2, 2006

(54) Preventing marine biofouling by inhibiting adhesive release from barnacles

(76) Inventors: Lena Martensson, Kungalv (SE); Fredrik Gunnarsson, Lysekil (SE)

Correspondence Address: LYNN E BARBER, P O BOX 16528, FORT WORTH, TX, 76162, US

(21) Appl. No.: 11/214,270

(22) Filed: Aug. 29, 2005

Related U.S. Application Data
(60) Provisional application No. 60/606,029, filed on Aug. 31, 2004.

(51) Int. Cl. A01N 43/62

(52) U.S. Cl. 424/78.09; 514/221

(57) ABSTRACT

Use of relatively harmless pharmacological substances, such as dopamine antagonists, that prevent the release of adhesive or in other way prevent the attachment of the barnacle larva. Dopamine antagonists are mixed with a paint polymer and applied on a ship hull, or any other man-made solid surface in the marine environment.

### CROSS-REFERENCE TO RELATED APPLICATIONS

This application claims priority from U.S Provisional Patent Application Ser. No. 60/606,029 filed Aug. 31, 2004.

### BACKGROUND OF THE INVENTION

1. Field of the Invention

The present invention relates generally to how to prevent barnacles from attaching to ship hulls or other marine constructions by adding dopamine antagonists to the protecting paint.

2. Description of the Prior Art

Marine biofouling has been a problem as long as we as humans have used the sea for any kind of transportation. The main goal has been to be as toxic as possible and rely on a broad toxic effect to kill any kind of marine life that attach to man-made marine constructions. The most commonly used substances throughout the years have been based on metals, such as mercury, lead, copper or tin. Mercury and lead are basically out of the market due to their toxic effects both on environment and on humans, and organic tin compounds are banned by the International Maritime Organization (IMO), which is waiting for a worldwide ratification. What will be more and more used is instead copper. The action of copper is a general metal poisoning which becomes lethal to the marine organisms. Copper is less toxic than the other compounds, but still, it cause bioaccumulation in the marine environment.

It can be appreciated that marine biofouling is one of the main problems regarding the marine industry. In any kind of marine industry phase, there are problems with biofouling leading to an increased fuel consumption and consequently increased emission of green house gases, the risk of invasive species, decreased maneuverability, increased problems with corrosion, and the need that offshore installations must be built in a way that they can tolerate metric tons of biofouling. These examples alone represent a huge economical cost but also a negative environmental impact due to the now available methods of preventing fouling. One major cause of marine biofouling is the attachment of barnacles to underwater structures, which is made possible by adhesive substances released by the barnacles. This adhesive is a glue that attaches the larvae to the substratum, the most critical event of the barnacle settlement process. In barnacles, the adhesive is a protein stored within a set of paired glands in the larvae. Other biofouling organisms with similar settlement mechanisms include tubeworms, polychaete worms, hydrozoans, bryozoa, tunicates and mussels, such as zebra-mussel.

The main problem with conventional antifouling biocides is that they are broadly toxic and rely on the toxic effect to exert the antifouling activity. Many contain different metal ions that bio-accumulate in the marine environment and have adverse effect on the marine environment and the marine organism's ecology.

The use of the dopamine antagonist SCH 23390 according to the present invention substantially departs from the conventional concepts and designs of the prior art, and in so doing provides products primarily developed for the purpose of providing a more environmentally friendly marine antifouling paint by acting to inhibit the release of barnacle adhesive and thereby preventing barnacle settlement.

The general purpose of the present invention, which will be described subsequently in greater detail, is to provide new products based on the invention that have many of the advantages the dopamine antagonist SCH 23390 (“SCH 23390”) either alone or in any combination with other more traditional anti-fouling solutions. To attain this, the present invention generally comprises products containing SCH 23390 in marine antifouling paints.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide the marine industry with more environmentally friendly marine antifouling paints.

An object of the present invention is to selectively inhibit the release of barnacle adhesive and thereby reducing the attachment and settlement of barnacles on ship hulls.

Another object is to provide the marine industry with a new biocide that is active at a very low concentration without being toxic either to the target organism or to non-target organisms.

Another object is to reduce the risk of using marine biocides that accumulate within the marine environment due to the environmental inability to degrade the substances and therefore risking bio-accumulation in the risk group. It is therefore more cost effective than presently known methods.

Other objects and advantages of the present invention will become obvious to the reader and it is intended that these objects and advantages are within the scope of the present invention.

### SUMMARY OF THE INVENTION

Establishing of barnacles, a crustacean, is a serious problem for the marine industry. This invention describes an environmentally friendly alternative to inhibit settlement of barnacles on solid surfaces. The invention contains the usage of relatively harmless pharmacological substances, such as dopamine antagonists, that prevent the release of adhesive or in other way prevent the attachment of the barnacle larva. Dopamine antagonists are mixed with a paint polymer and applied on a ship hull, or any other man-made solid surface in the marine environment.

### BRIEF DESCRIPTION OF DRAWINGS

FIG. 1 shows the accumulative barnacle settling frequency over 10 days with the presence of various treatments as discussed herein.

### DESCRIPTION OF THE PREFERRED EMBODIMENT

The present invention is based on advanced biological research on barnacle cypris larvae. We have found a method to prevent the release of the adhesive and by inhibiting this process, the barnacle cypris larvae are unable to attach themselves to the surface and thereby inhibit marine biofouling caused by barnacles.

Basically, the invention herein is a method and product for preventing marine biofouling of a substrate by a marine biofouling organism, comprising a protective coating and applying the protective coating to the substrate. The coating contains a receptor antagonist that inhibits release of adhesive by the marine biofouling organism. In its preferred embodiment, the receptor antagonist is a dopamine antagonist, preferably selected from D1 receptor antagonists and D5 receptor antagonists, and most preferably is SCH 23390 ((R)-(+)-7-Chloro-8-hydroxy-3-methyl-1-phenyl-2,3,4,5-tetrahydro-1H-3-benzazepine).

All the below described experiments are on the species Balanus improvisus.

The release of the adhesive is governed by a G-protein coupled receptor and it is possible to stimulate release of the adhesive glands by adding dopamine. According to the same principle, it is possible to block the release of the adhesive proteins by using a dopamine antagonist that block the action of dopamine. We have found that the antagonist SCH 23390 ((R)-(+)-7-Chloro-8-hydroxy-3-methyl-1-phenyl-2,3,4,5-tetrahydro-1H-3-benzazepine) (Tocris Cookson Ltd., Bristol, UK) can inhibit the release of barnacle adhesive. The invention herein includes use of SCH23390, and salts and derivatives thereof, as well as other D1 or D5 receptor antagonists such as propranolol, SCH 39166, SCH 233388 and the like or antagonists against other receptors with the same function.

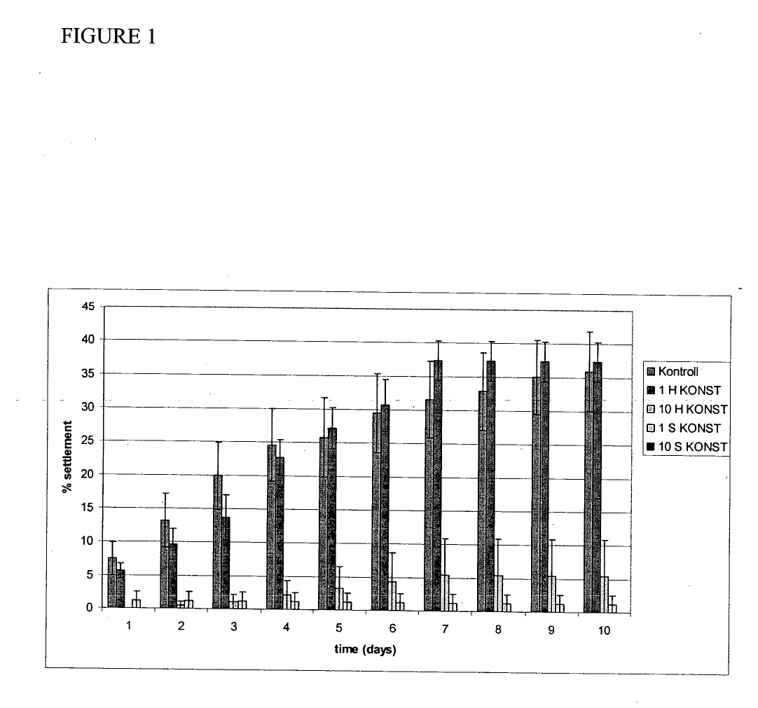

The following example shows how the settling and metamorphosis of barnacle cypris larvae is inhibited by SCH 23390. In a Petri dish containing 5 ml of filtered seawater, 20 cypris larvae and a defined concentration of the different pharmacological agents. FIG. 1 shows the settlement rate for barnacle cypris larvae. 20 barnacle cypris larvae were added into a Petri dish containing 5 ml filtered seawater and different concentration of haloperidole and SCH 23990. 1 μM SCH 23390 has an almost complete reducing effect of the settlement rate, whereas the haloperidol was less effective, proving the importance of the substance SCH 23390 as the more effective antifouling substance. FIG. 1 shows the accumulative barnacle settling frequency over 10 days with the presence of 1 μM haloperidol (1H), 10 μM haloperidole (10H), 1 μM SCH 23990 (1 S) and 10 μM SCH 23990 (10 S). This shows that SCH 23990 effectively inhibits the settling rate of barnacle cypris larvae in comparison with haloperidole as well as the control (Kontroll). The experiment shows that SCH 23390 is more effective than Haloperidole. Instead 1 μM of SCH 23390 inhibits the settling rate almost completely. Typically, 0.01-1.0% of the dopamine antagonist effects the desired result, typically dissolved in ethanol and mixed with commercially available paints, such as VC 17 New Technology (solid paint) International Coatings (Akzo Nobel bv, Arnhem, NL), SPF (Self polishing, SPC) (Loutrec AB, Lidingo, Sweden), TF (combined solid/ablative) (Loutrec AB), Fabi Eco (ablative paint) International Coatings (Akzo Nobel bv).

This is one example of how to prevent biofouling by inhibition of adhesive release. The advantage is that it is based on research that specifically inhibits a biological response. By doing so, it is possible to reduce the usage of heavy metal and bioaccumulation thereof in the marine environment. Further, the described effect is not lethal to the target organism, only preventing it from settling on a treated surface. By adding the dopamine antagonist SCH 23390 or other so called dopamine antagonists of the D1/5 subtypes or other receptors with the same function into a marine antifouling paint, it is possible to increase the effectiveness of the paint without negative impact on the marine environment.

As to a further discussion of the manner of usage and operation of the present invention, the same should be apparent from the above description. Accordingly, no further discussion relating to the manner of usage and operation will be provided.

While the invention has been described with reference to specific embodiments, it will be appreciated that numerous variations, modifications, and embodiments are possible, and accordingly, all such variations, modifications, and embodiments are to be regarded as being within the spirit and scope of the invention.

What is claimed is:

1. A method of preventing marine biofouling of a substrate by a marine biofouling organism, comprising applying a protective coating to the substrate, said coating containing a receptor antagonist that inhibits release of adhesive by the marine biofouling organism.

2. The method of preventing marine biofouling according to claim 1, wherein the receptor antagonist is a dopamine antagonist.

3. The method of preventing marine biofouling according to claim 1, wherein the receptor antagonist is (R)-(+)-7-Chloro-8-hydroxy-3-methyl-1-phenyl-2,3,4,5-tetrahydro-1H-3-benzazepine.

4. The method of preventing marine biofouling according to claim 1, wherein the receptor antagonist is selected from D1 receptor antagonists and D5 receptor antagonists.

5. The method of preventing marine biofouling according to claim 1, wherein the protective coating further comprises a marine paint.

6. The method of preventing marine biofouling according to claim 1, wherein the protective coating is prepared by dissolving the receptor antagonist in ethanol and mixing with a marine paint.

7. A product for preventing marine biofouling of a substrate by a marine biofouling organism, comprising a protective coating containing a receptor antagonist that inhibits release of adhesive by the marine biofouling organism.

8. The product for preventing marine biofouling according to claim 1, wherein the receptor antagonist is a dopamine antagonist.

9. The product for preventing marine biofouling according to claim 1, wherein the receptor antagonist is (R)-(+)-7-Chloro-8-hydroxy-3-methyl-1-phenyl-2,3,4,5-tetrahydro-1H-3-benzazepine.

10. The product for preventing marine biofouling according to claim 1, wherein the receptor antagonist is selected from D1 receptor antagonists and D5 receptor antagonists.

11. The product for preventing marine biofouling according to claim 1, wherein the protective coating further comprises a marine paint.

12. The product for preventing marine biofouling according to claim 1, wherein the protective coating is prepared by dissolving the receptor antagonist in ethanol and mixing with a marine paint.
